(19) United States
(12) Patent Application Publication
(10) Pub. No.: US 2009/0165033 A1
(43) Pub. Date: Jun. 25, 2009

(54) Content Viewing as an Incentive for Educational Activities

(75) Inventor: Paul Clancy, Duluth, GA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/959,761

(22) Filed: Dec. 19, 2007

(51) Int. Cl. H04N 7/16; H04N 7/173

(52) U.S. Cl. 725/25; 725/131

(57) ABSTRACT

Described herein are systems and methods for limiting television viewing while using such limited television viewing as a conditional incentive to encourage television viewers to engage in educational activities.

### BACKGROUND

In today's modern world of cable and satellite television services, most children are exposed to television long before they start school. Television can be a useful tool to provide children with educational programming, such as alphabet lessons for preschoolers typically found on public television, wildlife or nature shows, shows about current events, and shows that teach social and emotional interactions with other people in society. Thus, parents often wish to have control over how much time their children spend watching television and to leverage television viewing as an educational aid.

### BRIEF DESCRIPTION OF THE DRAWINGS

Embodiments are illustrated by way of example and not limited in the following figure(s), in which like numerals indicate like elements, in which:

FIG. 1 illustrates a host device in which an embodiment may be implemented;

FIGS. 2A-C illustrate various processes or methods for providing time limits for television viewing and using such limited television viewing as an incentive to engage television viewers in a learning experience.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

Described herein are systems and methods for limiting the amount of television viewing by viewers such as children and providing television viewing as an incentive or reward to viewers for performing educational activities.

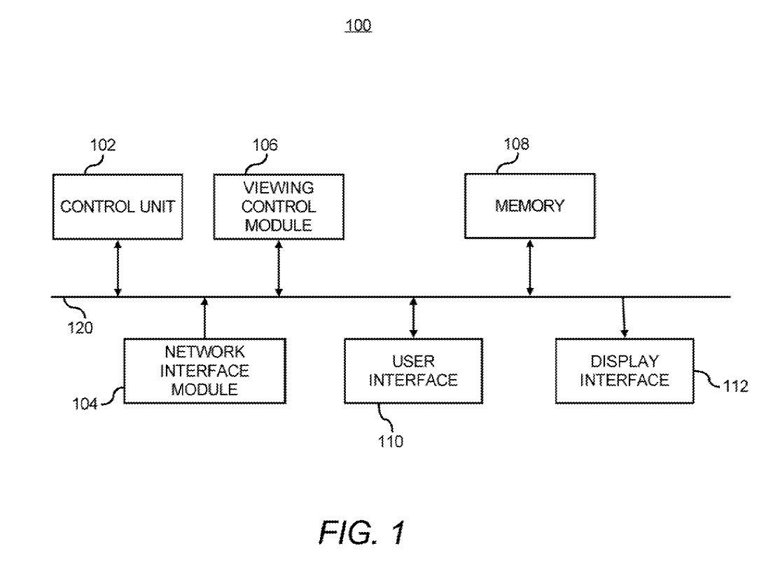

FIG. 1 illustrates a host device, such as a cable or satellite set top box (STB) in which an embodiment may be implemented therein. The host device 100 may be a standalone device that is operable to be connected to a media display to provide media content for viewing. For example, the host device 100 may be a STB connected to a television to provide television programming for viewing. Alternatively the host device 100 may be integrated in a media display. For example, a television set may be integrated with STB functionalities so that a cable- or satellite-access card may be inserted directly into the television set to allow access to television programming. Thus, as referred herein, a media display may be a television set or any other display device that is operable to display television programming or any other media content. For simplicity, the television set is used as an example of a media display throughout the present disclosure. However, it should be understood that other types of media display may be used without deviating from the scope of the present disclosure.

The host device 100 includes a control unit 102 having one or more processors to provide an execution platform for executing software. Thus, the control unit 102 includes one or more single-core or multi-core processors of any of a number of computer processors, such as processors from Intel, AMD, and Cyrix. As referred herein, a processor may be a general-purpose processor, such as a central processing unit (CPU) or any other multi-purpose processor or microprocessor. A processor also may be a special-purpose processor, such as a graphics processing unit (GPU), an audio processor, a digital signal processor, or another processor dedicated for one or more processing purposes. Commands and data from the processor 102 are communicated over a communication bus 120 (as shown in FIG. 1) or through point-to-point links with other components in the host device 100.

The host device 100 also includes a network interface module 104, a viewing control module 106, a memory 108, a user interface 110, and a display interface 112. The network interface module 102 enables the host device 100 to communicate with a content provider, such as a cable or satellite television provider, in a known manner to send and receive signals to the content provider. Thus, the network interface module 104 may include, for example, a tuner for tuning to different television channels, a modem for modulating signals to be sent to the content provider and demodulating signals received from the content provider, and a decrypter or decoder for decrypting content transmitted in the demodulated signals. Additionally, the network interface module 102 may include various connectors for interfacing and communicating with external devices. Examples of such connectors include but are not limited to universal serial bus (USB) connectors, IEEE 1394 (firewire) connectors, and Ethernet connectors, and any other known wire or wireless connectors.

The viewing control module 106 is operable to store and provide educational material or information to the viewers. As referred herein, educational material or information is any material or information that engages a viewer in intellectual or educational activities to assist with the viewer's intellectual development, skills, or knowledge. The educational material may include audio, visual, and/or multimedia representations of educational information or queries, such as multiple-choice questions, that quiz television viewers for correct answers before the EPG and television programming is made available through a media display. For example, educational questions such as math questions or questions for preparation of standardized tests (scholastic aptitude tests, achievement tests, etc.) that are appropriate for different ages may be included in the educational material stored in the viewing control module 106. In another example, reading comprehension or problem solving questions with short audio, video, or multimedia clips or presentations may be included in the educational material to allow viewers to read the passages, or view the video clips, before they are quizzed with questions about content in the presentations.

The educational material may be provided by a content provider, such as a television service provider, via spooling of the material at the television service provider (such as at the provider's headend server) for downloading as data packs to the viewing control module 106 via the network interface module 104 in the host device 100. In another example, the educational material may be provided by a third party via downloading of data packs from a data network, such as the Internet or a designated Intranet. The third-party downloading may be performed directly to the host device 100 or indirectly via an external storage device, such as an USB-enabled or firewire-enabled storage drive, which is then subsequently connected to the host device 100 via the network interface module 104 by a television viewer or user for downloading to the viewing control module 106 in the host device 100. This third-party downloading scheme may be further facilitated through the open cable standard, whereby STBs are standardized to be interoperable with different television service providers after purchase. Thus, the standardized STBs include a set of application programming interfaces (APIs) that may be used to download or import third-party products and services, such as the aforementioned educational material, into the STBs. The third party that provides the educational material may be a private or public entity that provides the educational material for a fee or as part of a required educational curriculum. For example, the third party may be a local public or private school that provides homework for downloading to the host device 100, so that its students must complete their homework before they can watch television.

The educational material may be automatically downloaded based on one or more predetermined conditions, for example, when the user or operator of the host device 100 is enrolled in a service that provides such educational material on a periodic basis. Additionally or alternatively, the educational material may be manually downloaded to the host device 100 when its user or operator requests such a download via the host device 100 (e.g., sending the request through a telephone line connected to the host device 100) or via an external device (sending the request by computer to a designated web site, calling by phone the request to a designated phone number, etc.)

The viewing control module 106 also stores content viewing rules or policies along with interactive functionalities to set conditions for content viewing and to receive user inputs via the user interface 110. Thus, the viewing control module 106 may include a computer readable medium (CRM) therein for storing educational material or information that may be viewed by and interact with television viewers, such as children, as a condition for viewing actual television programming. The condition for content viewing is based on the content viewing rules or policies also maintained in the CRM. Examples of a CRM include but are not limited to an electronic, optical, magnetic, or other storage device capable of storing data content and providing a processor, such as one in the control unit 102, with computer-readable instructions. Other examples of a suitable CRM include but are not limited to a floppy disk, CD-ROM, DVD, magnetic disk, memory chip, ROM, RAM, an ASIC, any optical medium, any magnetic tape or magnetic medium, or any other medium from which a processor is operable to read instructions.

The memory 108 may be implemented as a CRM having stored thereon software applications, programs, or modules. These software applications include computer executable instructions that are executable by the control unit 102 to provide any number of functions and operations of the host device 100. The memory 108 also may include software applications that is executed by the CPU 110 to provide digital or personal video recorder (DVR) functionalities, such as program recording, program playback (e.g., pause, rewind, forward), and recording timers. The memory 108 also includes software applications that may be executed by the CPU 110 to receive, store, and display an electronic program guide (EPG) from a television service provider, such as a cable or satellite television service provider. The EPG may be stored in a database that also resides in the memory 108 or any other suitable storage space in the host device 100. As referred herein, an EPG provides information or metadata about television programming that is available for viewing by the user. The available television programming includes programs provided by television broadcasting networks, pay-per-view (PPV) programs, and video-on-demand (VOD) programs. In an alternative embodiment, a single CRM may be provided to implement both the CRM of the memory 108 and the CRM of the viewing control module 106.

The user interface 110 is operable to receive user inputs from one or more input devices such as a television remote control, a keyboard, a mouse, a stylus, and/or any other human interface device (HID) that allows a user, such as a television viewer, to interact with the host device 100. For example, the user interface 110 allows the user to enter commands to view the programming services and applications available from the host device 100 and to select answers to questions conditional for television viewing. The user may also define or modify parameters of the host device 100, such as security policy data for the device, through the user interface 110.

The display interface 112 is operable for displaying media content, as provided by the host device 100, on a media display such as a television set connected thereto.

In operation, the control unit 102 commands the network interface module 104 to tune to a particular program or channel to receive content, such as television programming, from one or more content providers. It also commands the network interface module 104 to receive educational material from the content provider(s) or one or more third parties and store such material in the viewing control module 106. The control unit 102 then executes predetermined content viewing policies or rules also stored in the viewing control module 106, for example, to pose questions on the television set and receive answers from the viewers, check for correctness of the received answers, and proceed to lock up or make available the EPG and television programming for limited-time viewing through the television set based on the incorrect or correct answers. Accordingly, the viewing control module 106 provides conditions to viewers for television viewing. This encourages the viewers, such as children, to perform educational activities such as conducting research to find and learn the correct answers to the posed questions, such as educational questions, before they can watch television. Otherwise, they are locked out of television viewing.

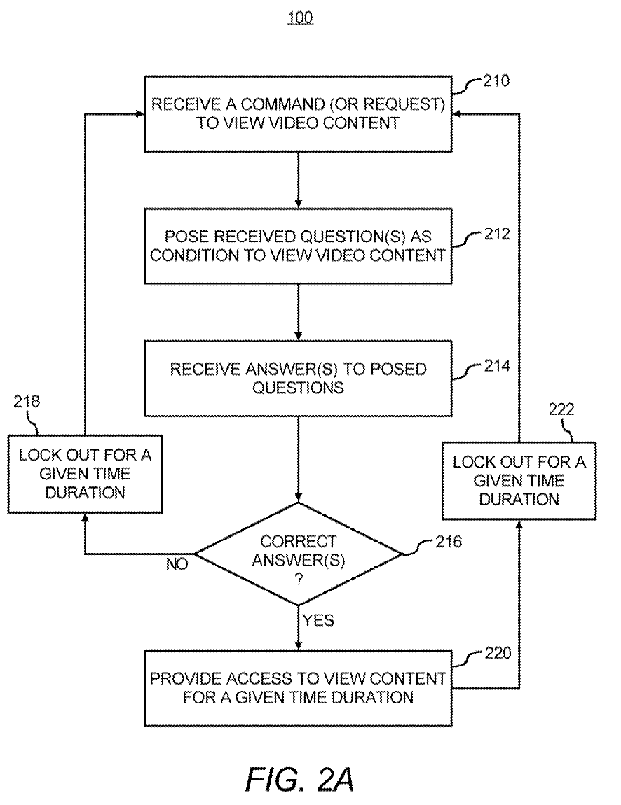

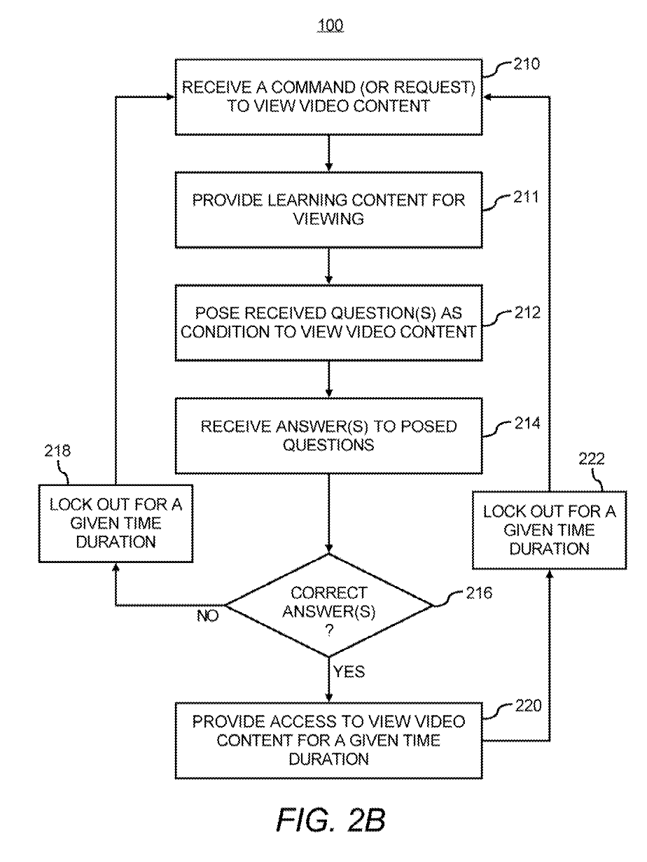

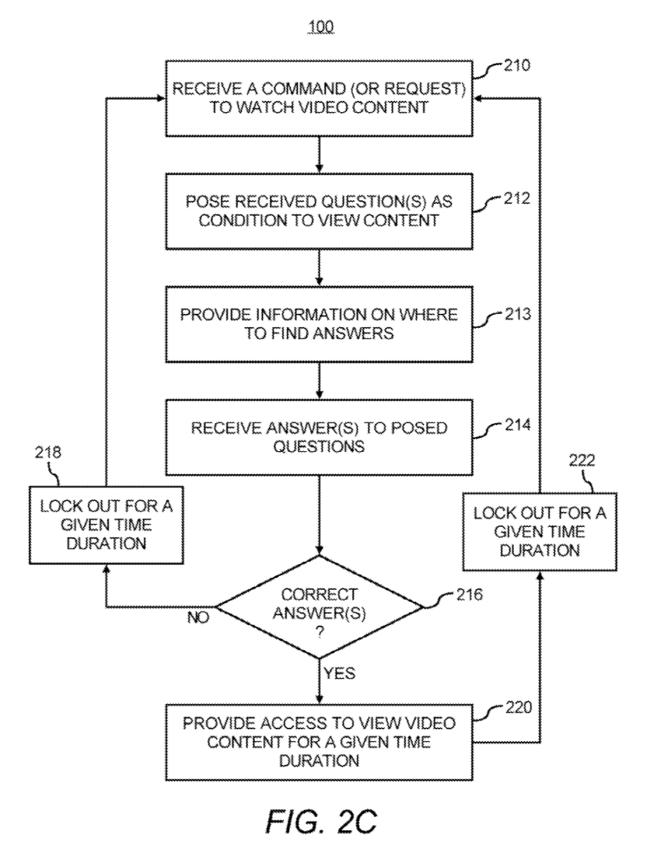

FIGS. 2A-C illustrate various processes or methods 200A-C for providing time limits for television viewing and using such limited television viewing as an incentive to engage television viewers in a learning experience. For illustrative purposes only and not to be limiting thereof, these methods are discussed in the context of the device 100 in FIG. 1. Thus, they may be implemented through execution of one or more software applications, programs, or modules stored in the host device 100.

The methods 200A-C may be implemented once the educational material for the aforementioned learning experience is available for use. For example, the host device 100 initially receives the educational material for storage in its memory 108, or any other memory or storage location in the host device 100. As discussed earlier, the educational material may be requested and then downloaded from the television service provider or a third-party. As also discussed earlier, in one example, the third party may be a school that provides homework as the educational material for downloading to host devices 100 used by its students to watch television. The educational material includes questions, such as educational multiple-choice questions, that quizzes television viewers, or homework to be completed, such as math problems to be completed or essays to be written. The educational material also may include answers to the aforementioned questions. As also discussed earlier, the educational material may be automatically or manually downloaded to the host device 100 on a periodic basis. Alternative embodiments are contemplated wherein the educational material may be dynamically downloaded as described below.

Referring first to the process 200A illustrated in FIG. 2A, at 210, the host device 100 (e.g., a STB) receives a request or command from a user (e.g., a television viewer) to access video content (e.g., television programming) to watch or view on a video display (e.g., a television set). For example, a child may turn on or otherwise activate a cable or satellite STB and a television set connected thereto to start watching television. In the case of a television set having components of the host device 100 integrated therein, the child may turn on the television set to start watching television.

At 212, in response to the request or command to view video content, such as television programming, the host device 100 initiates a learning session to randomly or orderly pose one or more of the received questions on the television set and request one or more answers to each of the posed questions from the television viewer as a condition for accessing the television programming. In the case where the educational material is dynamically downloaded, it may be downloaded, for example, from the television service provider or a designated third-party, in response to the viewing command at 210, before one or more questions, homework assignments, or other educational activities therein are posed to the television viewer.

At 214, the host device 100 receives an answer, or an upload of a completed homework assignment (such as a data file) for each of the posed questions from the television viewer. As discussed earlier, the television viewer may employ a user interface device, such as a remote control, that is associated with the host device 100 to transmit or select the correct answers provided on the tv screen for receipt by the user interface 114 in the host device 100.

At 216, the host device 100, through its executed software application(s), determines whether the received answers are the correct ones for the posed questions based on the educational material received, or whether a data file has been uploaded (e.g., when a completed homework assignment is required as a condition for television viewing).

At 218, if one or a percentage of the received answers is incorrect (or a data file or a percentage of the required data files has not been uploaded), the host device 100 proceeds to lock out or deactivate itself for viewing for a predetermined or set amount of time or until the correct answers (or data files) are received. As referred herein, the device lock-out removes the availability of content from host device 100 for viewing, such as the availability of television programming for viewing through a television set or a STB connected thereto. The device lock-out also prevents the television viewer from continuing to make guesses until the right answer is found or to try another question. For example, the host device 100 may lock out so that when it is turned on, neither television programming nor questions can be viewed. Instead, the television viewer may be greeted with a message indicating that the host device 100 is locked out for a set duration of time, such as 3 hours, that is deemed sufficient for the television viewer to conduct research and find the correct answers to those questions that were missed. After the set duration of time, the host device 100 automatically unlocks itself to accept any new request or command to view content on the video display again. Thus, the process 200 is restarted at 210. Once it is turned on or otherwise activated again at 210, it initiates another learning session to pose the same question(s) found in the previous learning session before lock out.

At 220, If the received answer(s) are correct (or it is determined that a data file has been uploaded), the host device 100 provides the television viewer with video content, such as the EPG and television programming, for viewing for a set time duration. This set time duration for viewing may be based on time units, such as the number of hours of viewing television programming (e.g., 2 hours), or the number of television programs for viewing (e.g., 2 television shows or 1 movie) as may be determined from the available EPG, or any combination thereof. Also, the total time duration for television viewing, regardless whether corrected answers are provided in multiple learning sessions, may be limited (e.g., 60 hours of viewing per month). After the aforementioned time duration, the host device 100 initiates another session to pose another set of question(s) for the television viewer to answer, should the viewer wishes to continue watching television. The process 200 is then restarted at 210. At this juncture, if a required data file has been uploaded to the host device 100, the host device 100 further proceeds to forward the data file, via the network interface module 106, to a predetermined entity. For example, if the required data file represents completed homework previously assigned by a school, the data file may be forwarded to the school's server.

Alternatively, at 222, to prevent the television viewer from continuous television viewing, the host device 100 may be locked out for a set duration of time before it can be turned on or otherwise activated again at 210 for the process 200 to restart. For example, the host device 100 may allow a total of 4 hours of television viewing in any 24-hour period, regardless whether the user continues to meet the conditions for television viewing subsequent to the allotted 4 hours.

In an alternative embodiment, the features at 216-220 may be modified as follows. At 216, the host device 100 further calculates the percentage of questions that have been answered correctly (or the number of data files that have been uploaded). Then, at 218, unless all posed questions were answered incorrectly (or no required data file was uploaded), the host device 100 does not lock out for television viewing. Instead, at 220, the host device 100 provides the television viewer with access to the EPG and television programming for a time duration pro-rated based on the percentage of questions that have been answered correctly (or the percentage of the required data files that have been uploaded). For example, if none of the posed questions were answered correctly (or no data file was uploaded), the host device 100 is locked out. In another example, if 8 questions were posed (or 8 homework assignments are required to be completed) that would have provided 2 hours of television programming for viewing, and only 4 were answered correctly (or only 4 data files were uploaded to represent only 4 completed homework assignments), then the television viewer is allowed only 1 hour of television programming for viewing.

Alternative embodiments are contemplated wherein after each limited television viewing event, the questions posed at 212 get harder to present additional educational challenges to the television viewer and may further limit television viewing.

FIG. 2B illustrates another process 200B that is the same as the process 200A discussed above, except with additional features at 211 to provide educational or learning content for the television viewer to watch as part of the learning session. That is, at 211, in response to the request or command from a viewer to access video content for viewing on a video display at 210, the host device 100 initiates a learning session that includes learning content, such as an educational audio, video, or multimedia presentation, that the viewer can watch or view on the television set. Then, at 212, the viewer is presented with one or more questions about the viewed learning content as a condition for the viewer to watch other desired content available through the host device 100, and so on as described earlier with FIG. 2A.

FIG. 2C illustrates yet another process 200C that is the same as the process 200A discussed above, except with additional features at 213 to provide the television viewer with information on how or where to obtain or find answers to the posed questions at 212. For example, the host device 100 may provide an audio, video, or multimedia presentation for viewing, from which the television viewer may obtain answers to the posed questions. The provided audio, video, or multimedia presentation may be an educational channel that the host device 100 sets up for viewing at any time, even when it is under lock out, to encourage the television viewer to watch and learn from such channel when nothing else is available for viewing. It may be a television program on a television channel that will automatically be unlocked for viewing at its scheduled time. The presentation also may be video content, such as a video clip, saved in the host device 100 as part of the educational material. Then, the user is able to view the presentation and subsequently answer the posed question(s). In another example, the host device 100 may provide directions, including any required passwords, to access one or more websites or portals on the Internet, to research answers to the posed questions. These Internet websites or portals may be set up by the same entity that provides the educational material or by other entities. In the interim, the host device 100 may be locked-out until it is turned on or activated again, and the process 200C is repeated with the same posed question(s) so that the viewer is able to submit answers that were researched.

An alternative process is contemplated wherein both the features at 211 and 213 are incorporated, in the manners described above, into the process 200A illustrated in FIG. 2A.

The processes shown in FIGS. 2A-C may be implemented in a general, multi-purpose or single purpose processor. Such a processor will execute instructions, either at the assembly, compiled or machine-level, to perform that process. Those instructions can be written by one of ordinary skill in the art following the description of FIGS. 2A-C and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Accordingly, the systems and methods as described herein provide limited television viewing so that television viewers such as children will have more time to better spend doing healthy physical activities, interacting with parents and others, and exploring and learning the physical real world outside the television screen. Furthermore, the limited television viewing is provided as a conditional incentive to encourage the children, and other television viewers, to engage in learning and other educational endeavors as desired.

What has been described and illustrated herein are various embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for providing television viewing as an incentive for learning comprising:
receiving educational material, the educational material includes educational questions for quizzing;
receiving a request to view content on a media display;
responsive to the request to view content on the media display, posing at least one of the educational questions on the media display;
receiving at least one answer to the at least one educational question from a viewer of the media display;
determining whether the received at least one answer is correct or incorrect based on the predetermined answers received; and
responsive to the determining that the received at least one answer is incorrect, locking out the media display to prevent a viewing of the content on the media display.

2. The method of claim 1, wherein locking out the media display comprises:
locking out the media display for a first predetermined time duration before accepting to receive a new request to view content on the media display and initiate another learning lesson.

3. The method of claim 1, further comprising:
responsive to the determining that the received at least one answer is correct, displaying for a second predetermined time duration the content on the media display for viewing.

4. The method of claim 3, further comprising:
subsequent to the displaying of the content for the second predetermined time duration, locking out the media display for a third predetermined time duration before accepting to receive a new request to view content on the media display.

5. The method of claim 1, further comprising:
responsive to the request to view content on the media display, providing a display of learning content on the media display, and the posed at least one educational question is about the learning content displayed.

6. The method of claim 1, further comprising:
providing information on where to find an answer to the at least one educational question posed.

7. The method of claim 1, wherein providing information on where to find an answer includes:
providing access to a television channel for educational viewing on the media display, from which the answer to the at least one educational question is made available.

8. The method of claim 1, wherein receiving the educational material for storage comprises one of:
automatically downloading the educational material from a learning-material provider on a periodic basis; and
manually downloading the educational material from the learning-material provider as desired.

9. A host device operable to provide television viewing as an incentive for learning, the host device comprises:
a processing unit;
a computer readable medium on which is stored educational material and an application, the educational material includes educational questions for quizzing and predetermined answers to the educational questions, the application is executed by the processing unit to:
receive a request to view content on a media display;
responsive to the request to view content on the media display, posing a plurality of educational questions on the media display to initiate a learning session;
receive answers to the plurality of educational questions from a viewer of the media display;
determine whether the received answers are correct or incorrect based on the predetermined answers received;
calculate a percentage of the received answers that are determined to be correct; and
display for a first predetermined time duration the content on the media display for viewing, wherein the first predetermined time duration is pro-rated based at least on the percentage of the received answered that are determined to be correct.

10. The host device of claim 9, further comprising:
a network interface module that operates to download the educational material for storage in the data storage medium.

11. The host device of claim 9, wherein the first predetermined time duration is further based on information in an electronic program guide (EPG) stored in the host device.

12. The host device of claim 9, wherein the host device is a set top box that operates to provide television programming to the media display connected thereto.

13. The host device of claim 9, wherein the host device is the media display that operates to display the content for viewing.
